(19) United States
(12) Patent Application Publication
(10) Pub. No.: US 2022/0065021 A1
(43) Pub. Date: Mar. 3, 2022

(54) COOKING AND WARMING OVEN WITH NO-TOUCH MOVEMENT OF CABINET DOOR

(71) Applicant: Donald W. Wisner, Grand Haven, MI (US)

(72) Inventor: Donald W. Wisner, Grand Haven, MI (US)

(73) Assignee: Haven Innovation, Inc.

(21) Appl. No.: 17/461,786

(22) Filed: Aug. 30, 2021

Related U.S. Application Data
(60) Provisional application No. 63/071,649, filed on Aug. 28, 2020.

(51) Int. Cl. E05F 15/73; F24C 15/04; E05F 15/60; E05F 15/79; E05F 17/00

(52) U.S. Cl. CPC E05F 15/73; F24C 15/04; E05F 15/60; E05F 15/79; E05F 17/004; E05Y 2900/308; E05Y 2201/434; E05Y 2400/40; E05Y 2400/44; E05Y 2400/86; E05F 2017/008

(57) ABSTRACT

A cooking oven for warming food includes a housing and a heat source for heating a interior compartment within the housing. One or more doors are used for providing access to the compartment and a no-touch sensor for detecting user actuation of the door(s). Control circuitry utilizes the no-touch sensor to detect user actuation outside the compartment that signals the door(s) to open and likewise to close on command or via a preprogrammed time. A position sensing system interfaces with the electro-mechanical door open/close device to control door speed and positioning.

### FIELD OF THE INVENTION

The present invention relates generally to cooking and warming ovens and more particularly to a cooking or warming oven having no-touch open and close cabinet doors.

### BACKGROUND

The on-set of the COVID-19 virus has brought about many concerns with persons touching objects. This is particularly true with regard to food preparation. In many environments, such as the workplace, persons cannot always wear gloves before touching objects. Moreover, in many cases, a common appliance might be used in a kitchen setting where many people may touch the appliance in the course of its use. Since cleaning between uses is not possible, alternative solutions are needed to minimize human contact and prevent the spread of pathogens in the normal course of use.

Cooking and warming ovens with motorized doors are known in the art however, these devices typically require the user to pre-program the time(s) the oven doors will open. This also requires the user to touch the device to actuate the door(s). Accordingly, new solutions are needed to assist uses to prevent the spread of bacteria, viruses and other germs causing communicable disease.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating the electrical architecture used in an embodiment of the invention.

FIG. 2A, FIG. 2B, FIG. 2C, FIG. 2D, FIG. 2E, FIG. 2F, FIG. 2G, FIG. 2H, FIG. 2I, FIG. 2J and FIG. 2K are illustrations showing the sequence of a user opening the door to insert a food container for cooking and then removing the food tray at some predetermined time upon completion.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a cooking or warming oven with no touch movement of cabinet doors. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

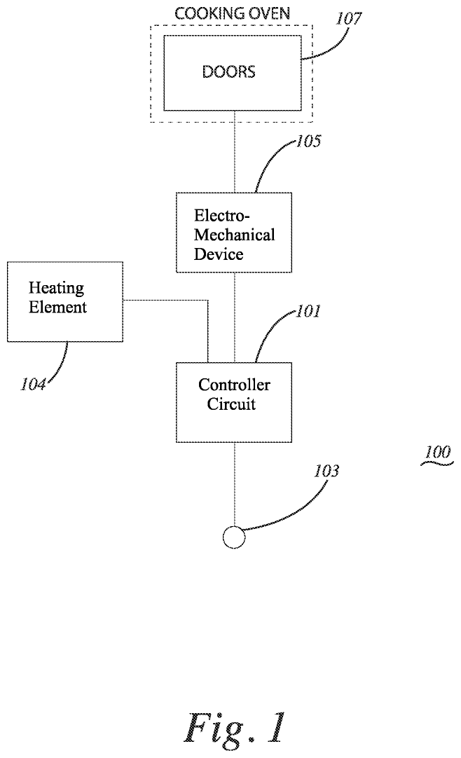

FIG. 1 is a block diagram illustrating the electrical control system used in an embodiment of the invention. The electrical control system 100 includes control circuitry 101 that uses a no-touch senor 103 used for actuating the oven doors. In use, the oven doors are typically transparent enabling the user to see the food warming but may also be opaque. Those skilled in the art will recognize that any type of sensor may be used where the no-touch sensor 103 may detect changes in photoelectric parameters, temperature, user proximity, pressure, position, nearby capacitance or other environmental parameters used to determine that the user wishes to change the position of the doors. The sensor 103 can be actuated by any means such the user's hands, body as well as other forms of actuation such as the user's voice or the like. By way of example and not limitation, one embodiment might include situations where the user can pass their hand in front of the touchless sensor 103 to open the oven doors. The door then closes either automatically after some predetermined time period e.g., 20 seconds, or upon another touchless command. In some embodiments, the doors may also be manually closed.

In use, the control circuitry interfaces with the no-touch sensor, the electro-mechanical device used for door opening and closing, and a sensor system for controlling door open and close speed and position. In one example, the electromechanical device 105 might be a motor or other actuator that is mechanically connected to one or more oven doors 107. The electromechanical device 105 works to open and close door position with forward and reverse movement of the motor. In some embodiments, the control circuitry 101 can also detect position of the doors so the rate of their movement can be slowed when the door(s) are moving into a closed position. One or more heating elements 104 may be integrated into one or more shelves inside the oven compartment or interior for heating food containers positioned on the shelves within the warming oven housing.

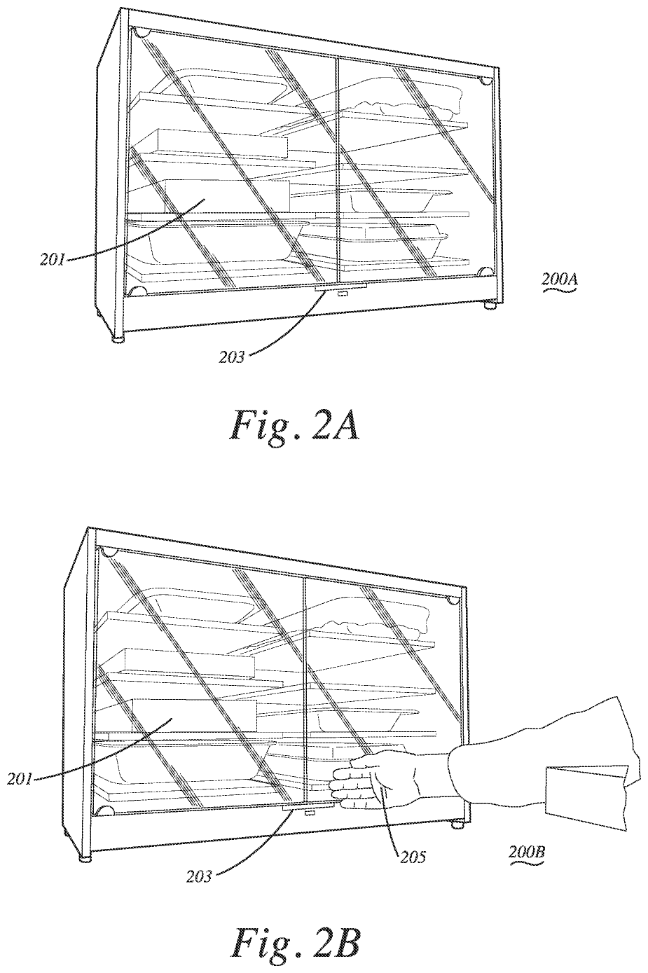

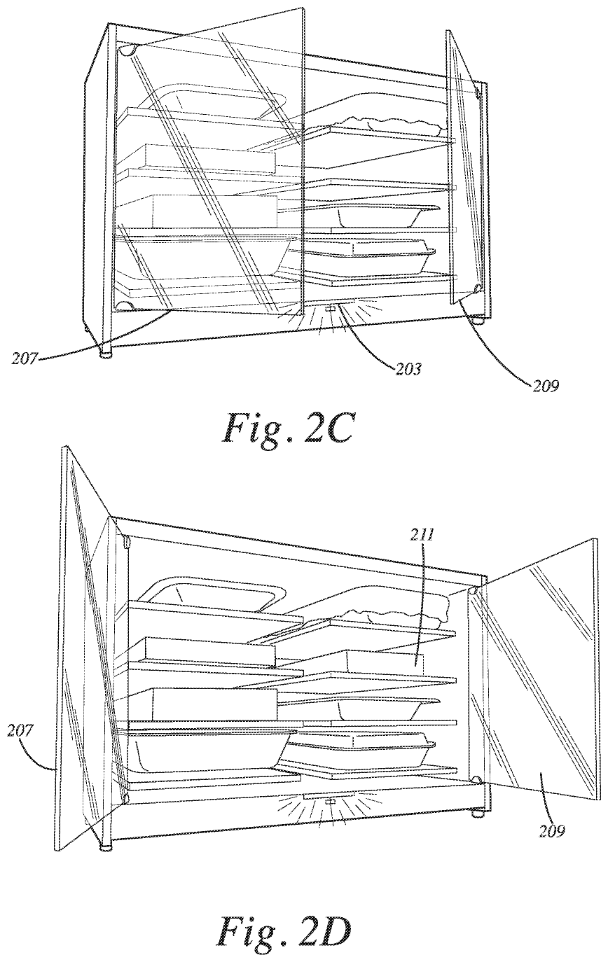

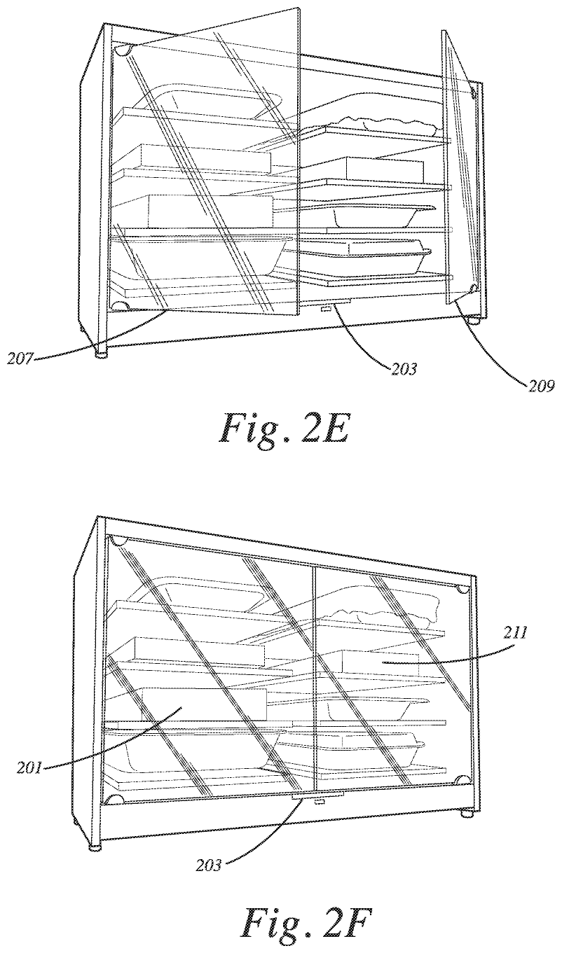

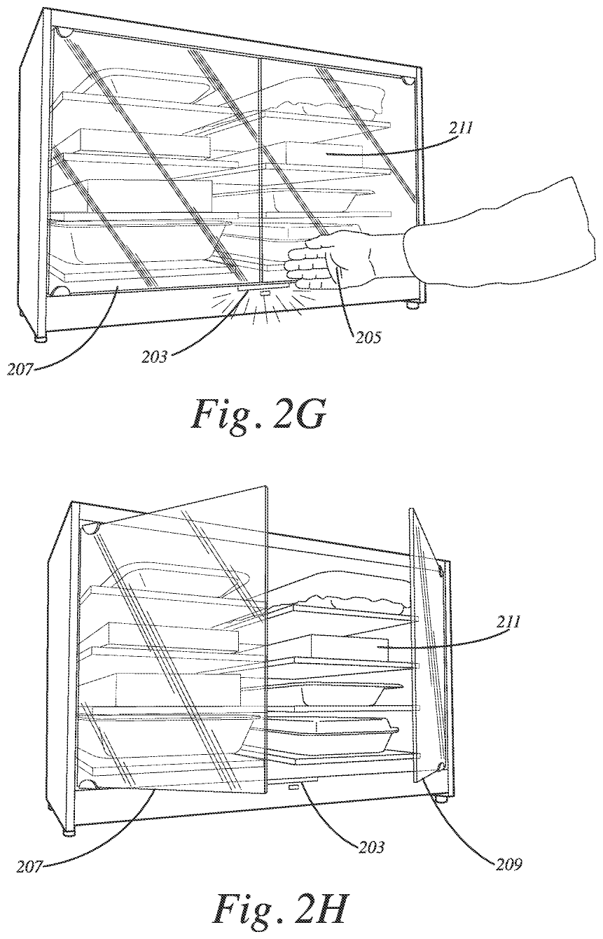

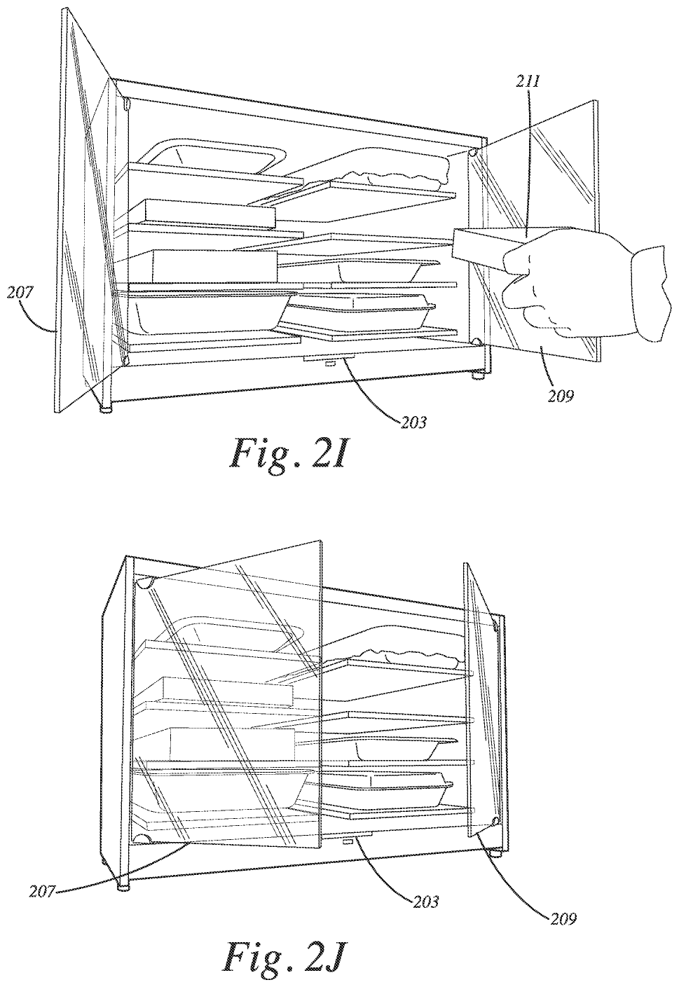

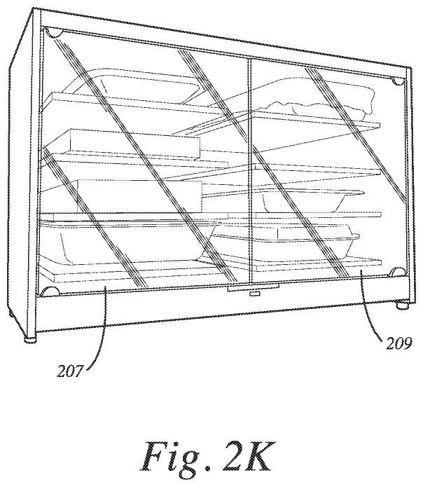

FIG. 2A, FIG. 2B, FIG. 2C, FIG. 2D, FIG. 2E, FIG. 2F, FIG. 2G, FIG. 2H, FIG. 2I, FIG. 2J and FIG. 2K are illustrations showing the sequence of a user opening the oven doors to insert a food container for cooking and then removing the food tray at some predetermined time upon completion.

FIG. 2A shows the oven 201 in a static position with both the left door and right door in a closed position. A non-touch sensor 203 uses an indicator light that can be a specific color for showing the door in a closed position. Although illustrated in FIG. 2A as centered between doors, those skilled in the art will recognize that other positions of the senor either above or to the side of the oven doors is also possible. In some embodiments, the sensor 203 may be integrated within the glass or plastic doors.

FIG. 2B illustrates a user passing their hand 205 in close proximity to the front of the non-touch sensor 203 in order to actuate the doors opening. FIG. 2C illustrates the indicator light has changed status e.g., a color change from red-to-green indicating the oven doors 207, 209 are moving and in transition. Although indicators may be configured using different colors such as green and red other colors, sounds or labeled indicia might also be used to indicate the opening or closing of the doors.

FIG. 2D illustrates the doors in a fully open position where the user has inserted a food container 211 inside the oven for cooking.

FIG. 2E illustrates the doors closing where the indicator light has again changed status e.g. red indicating the oven door 207, 209 is in a transitional state.

FIG. 2F illustrates the oven doors 207, 209 fully closed where the food container 211 can be heated for some predetermined time period.

FIG. 2G illustrates the food container 211 that has been adequately heated where the user passes their hand again in the proximity of the no-touch sensor 203 to open oven doors 207, 209. The food container 211 remains in the oven behind the glass doors.

FIG. 2H illustrates oven doors 207, 209 opening, exposing the food container 211 and allowing it to be removed.

FIG. 2I illustrates the doors fully opened where the user can remove the food container 211.

FIG. 2J illustrates the oven after some predetermined time period e.g., 20 seconds or other touchless command where the doors 207, 209 will automatically close and the indicator light again changes color status indicting the doors in a transitional state.

Finally, FIG. 2I illustrates the oven doors 207, 209 fully closed where the oven remains operating to heat other food containers therein.

Thus, the present invention is a cooking and warming oven having no-touch movement of cabinet doors where a control system in the oven uses a no-touch sensor to detect movement and/or other actuating parameters to automatically open and close the doors. The oven allows multiple users to fully cook food containers and remove them from the oven without touching any part of the oven preventing the spread of bacterial and viral pathogens.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A cooking oven comprising:
a housing;
a heating source configured within an oven compartment;
at least one door for providing access to the oven compartment;
a no-touch sensor for receiving user commands, and
control circuitry that utilizes the no-touch sensor for providing actuation of the at least one door to open the door by motion command and automatically closing the at least one door after some predetermined period.

2. A cooking oven as in claim 1, further comprising an electro-mechanical device operated by the control circuitry for controlling movement of the at least one door.

3. A cooking oven as in claim 3, wherein the electro-mechanical device works with an electric motor.

4. A cooking oven as in claim 1, wherein the no-touch sensor is located below the at least one door.

5. A cooking oven as in claim 1, wherein the at least one door is substantially transparent.

6. A cooking oven as in claim 1, wherein the at least one door is two doors.

7. A cooking oven comprising:
a housing having a plurality of shelves therein;
a heating source integrated within each one of the plurality of shelves;
at least one door for providing access to the plurality of shelves;
a no-touch sensor for receiving user commands; and
control circuitry that utilizes the no-touch sensor for providing actuation of the at least one door for opening the door when in proximity to the no-touch sensor and automatically closing the at least one door after some predetermined time.

8. A cooking oven as in claim 7, further comprising an electro-mechanical device operated by the control circuitry for controlling movement of the at least one door.

9. A cooking oven as in claim 7, wherein the electro-mechanical device works with an electric motor.

10. A cooking oven as in claim 7, wherein the no-touch sensor is located below the at least one door.

11. A cooking oven as in claim 7, wherein the at least one door is substantially transparent.

12. A cooking oven as in claim 7, wherein the at least one door is two doors.

13. A cooking oven for warming food comprising:
a housing having a plurality of shelves therein;
a heating source integrated within each one of the plurality of shelves;
a first door and second door for providing access to the plurality of shelves;
a no-touch sensor positioned below the first door and second door for receiving user commands;
control circuitry that utilizes an input from the no-touch sensor for providing actuation of the plurality of doors for opening at least one of the plurality of doors when in proximity to the no-touch sensor and automatically closing the at least one door after some predetermined time; and
wherein the no-touch sensor is actuated by user hand commands.

14. A cooking oven as in claim 13, further comprising an electro-mechanical device operated by the control circuitry for controlling movement of the at least one door.

15. A cooking oven as in claim 13, wherein the electro-mechanical device works with an electric motor.

16. A cooking oven as in claim 13, wherein the at least one door is substantially transparent.
